(19) United States
(12) Patent Application Publication
(10) Pub. No.: US 2014/0175697 A1
(43) Pub. Date: Jun. 26, 2014

(54) Modified Long Chain Polyamide

(71) Applicant: TAIWAN TEXTILE RESEARCH INSTITUTE, New Taipei City (TW)

(72) Inventors: Wei-Hung Chen, New Taipei City (TW); Ta-Yo Chen, New Taipei City (TW); Tsai-Wen Chen, New Taipei City (TW); Wei-Hsiang Lin, New Taipei City (TW)

(73) Assignee: TAIWAN TEXTILE RESEARCH INSTITUTE, New Taipei City (TW)

(21) Appl. No.: 13/726,692

(22) Filed: Dec. 26, 2012

(51) Int. Cl. C08G 69/00

(52) U.S. Cl. CPC C08G 69/00
USPC 264/211.24; 528/347

(57) ABSTRACT

A modified long chain polyamide is provided. The modified long chain polyamide is polymerized by monomers comprising a long-aliphatic-chain monomer, and equimolar of an aromatic diacid and polyethyleneoxy diamine. A fiber made from the modified long chain polyamide is also provided.

### BACKGROUND

1. Technical Field

The disclosure relates to polyamide. More particularly, the disclosure relates to a modified polyamide.

2. Description of Related Art

A “long chain” polyamide (abbreviated as PA) is typically defined as a polyamide with a repeating unit monomer having at least 10 carbons. Long chain polyamide has many advantages, such as low density, long-lasting bacteriostatic property (US 2010/0318012), softness, and wear resistance. These polymers can be entirely or partially derived from renewable sources. For example, PA1010 comes from sebacic acid, which in turn is derived from castor oil. Castor oil is one of the world's most versatile natural products, and is obtained from castor plants (non food competitive). It's well known that the long chain polyamide has lower hydrogen bond density. Therefore, the long chain polyamide has poor moisture absorption and desorption rates. This drawback cause that the long chain polyamide has low moisture content, and thus the flowability of the melted long chain polyamide is poorer. Therefore, in the melt spinning process, the low moisture content cause the melt spinning temperature of the long chain polyamide is higher than normal PA6. For example, the melt spinning temperature of PA11 is 290° C., but the melt spinning temperature of PA6 is only 260° C.

The drawback of poor moisture absorption and desorption rates can be improved by incorporating polyethyleneoxy (PEO) diamine into the backbone of the long chain polyamide by copolymerization to increase the moisture absorption and desorption rates of the long chain polyamide. However, the reactivity between the polyethyleneoxy diamine and the monomers of the long chain polyamide is extremely low, and hence this modification method is not suitable for long chain polyamide.

Therefore, a method is needed to effectively increase the reactivity of copolymerizing the PEO diamine and the monomer(s) of the long chain polyamide. Then, the moisture absorption and desorption rates of the long chain polyamide can be increased, and the melt spinning temperature of the long chain polyamide can be solved at the same time.

### SUMMARY

Accordingly, in one aspect, the present invention is directed to a modified long chain polyamide that can react with polyethyleneoxy diamine and melt spinning both at the normal operational temperature of PA6.

The modified long chain polyamide is polymerized by monomers comprising a long-aliphatic-chain monomer, and equimolar of an aromatic diacid and polyethyleneoxy diamine (PEO diamine). The long-aliphatic-chain monomer has an amine group and a carboxylic group, and 11-18 carbons. The added amount of the long-aliphatic-chain monomer is 100 parts by weight, and the added amount of the PEO diamine is 1-30 parts by weight.

According to an embodiment, the long-aliphatic-chain monomer can be 11-aminoundecanoic acid or 12-aminododecanoic acid, for example.

According to another embodiment, the aromatic diacid can be terephthalic acid, isophthalic acid, bibenzoic acid, naphthalene dicarboxylic acid, 4,4′-biphenyl dicarboxylic acid, bis(p-carboxyphenyl) methane, ethylene bis(p-benzoic acid), 1,4-tetramethylene bis(p-oxybenzoic acid), ethylene bis(p-oxybenzoic acid), or 1,3-trimethylene bis(p-oxybenzoic acid), for exmaple.

In another aspect, this invention also direct to a fiber melt spun from the modified long chain polyamide above.

Accordingly, the embodiments above of this invention can perform copolymerization reaction at a lower temperature with a faster reaction rate, and can be melt spun at the operation temperature of PA6. Therefore, the advantages of the long chain polyamide can be more to play in functional fabrics.

The foregoing presents a simplified summary of the disclosure in order to provide a basic understanding to the reader. This summary is not an extensive overview of the disclosure and it does not identify key/critical elements of the present invention or delineate the scope of the present invention. Its sole purpose is to present some concepts disclosed herein in a simplified form as a prelude to the more detailed description that is presented later. Many of the attendant features will be more readily appreciated as the same becomes better understood by reference to the following detailed description considered in connection with the accompanying drawings.

### BRIEF DESCRIPTION OF THE DRAWINGS

FIG. 1 is a diagram of torque measured during the polymerization of examples E4, C1, and C2.

### DETAILED DESCRIPTION

Accordingly, a modified long chain polyamide is provided. This long chain polyamide can be polymerized at a lower temperature than PA6, and also can be melt spun at the melt spinning temperature of PA6. In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

The reason for the extremely low reactivity of the polyethyleneoxy diamine and the monomers of the long chain polyamide is lied in that the better crystalline of the long chain polyamide, and the long carbon chains of the polyamide can build a bulkier steric hindrance for the addition reaction between the polyethyleneoxy diamine and the monomers of the long chain polyamide.

In the embodiments of this invention, an aromatic diacid monomer is added to copolymerize with the monomer of the long chain polyamide and the polyethyleneoxy diamine to decrease the copolymerization temperature and also the melt spinning temperature.

### Modified Long Chain Polyamide

Monomers of modified long chain polyamide comprise the following monomers. A first monomer is a long-aliphatic-chain monomer, which has 11-18 carbons and has an amine group and a carboxylic acid group. For example, the long-aliphatic-chain monomer can be 11-aminoundecanoic acid or 12-aminododecanoic acid.

A second monomer is polyethyleneoxy diamine to increase the moisture absorption and desorption rate of the obtained modified polyamide. The average molecular weight of the polyethyleneoxy diamine can be 900-2000, such as 900, 1000, 1100, 1200, 1300, 1400, 1500, 1600, 1700, 1800, 1900, or 2000.

A third monomer is an aromatic diacid, which has a chemical formula of HOOC—Ar—COOH, and Ar is a divalent aromatic group. For example, the aromatic diacid can be terephthalic acid, isophthalic acid, bibenzoic acid, naphthalene dicarboxylic acid, 4,4′-biphenyl dicarboxylic acid, bis(p-carboxyphenyl) methane, ethylene bis(p-benzoic acid), 1,4-tetramethylene bis(p-oxybenzoic acid), ethylene bis(p-oxybenzoic acid), or 1,3-trimethylene bis(p-oxybenzoic acid).

The added amount of the aromatic diacid is determined by the added amount of polyethyleneoxy diamine, since the aromatic diacid was used to balance the molar number of the polyethyleneoxy diamine. That is, the molar number of the aromatic diacid is about equal to the molar number of the polyethyleneoxy diamine.

The aromatic diacid is used to decrease the crystallinity of the long-aliphatic-chain monomer, such that the steric hinderance encountered during the copolymerization reaction can be decreased to increase the reaction rate, and thus decrease the reaction temperature. Furthermore, since the obtained modified polyamide incorporate the aromatic diacid into the polymer backbone of the modified polyamide, the melting temperature of the modified polyamide also can be decreased, and thus the melt spinning temperature can be decreased, too.

When a copolymerization reaction is going to be performed, the long-aliphatic-chain monomer, polyethyleneoxy diamine, and the aromatic diacid can be added in a reactor in one time at a temperature of 210-260° C. and a pressure of 0.1-200 torr. The added amount of the long-aliphatic-chain monomer, and polyethyleneoxy diamine can be 100 parts by weight, and 1-30 parts by weight, respectively.

### Fibers of Modified Long Chain Polyamide

The fibers of the above modified long chain polyamide can be obtained by melt spinning the above modified long chain polyamide at a temperature of 230-260° C. The obtained fibers have strength of about 4-5 gf/d, and elongation rate of about 30-40%. Therefore, the obtained modified PA fibers can be applied in textile industry.

A fabric made from the modified PA fibers above has moisture absorption rate of about 3-4%, and moisture desorption rate of about 1.5-2.5%. Therefore, the fabric above can provide more comfortless to a wearer.

### Experiment 1: Monomer Composition of Long Chain Polyamide

First, the monomer composition of the prepared long chain polyamide is described. In examples E1-E4 and C1-C2, the long-aliphatic-chain monomer used was c, and the added amount was 1000 g. The added amount of polyethyleneoxy (PEO) diamine, the kinds and added amount of the diacid monome are listed in the table 1 below.

TABLE 1
Monomer composition of long chain polyamide

| | |
|---|---|
| PEO diamine | diacid |

| Example | g | mol | kinds | mol |
|---|---|---|---|---|
| E1 | 0 | 0 | — | — |
| E2 | 87 | 0.0263 | terephthalic acid | 0.0263 |
| E3 | 174 | 0.0868 | terephthalic acid | 0.0868 |
| E4 | 229 | 0.1144 | terephthalic acid | 0.1144 |
| C1 | 228 | 0.1141 | adipic acid | 0.1141 |
| C2 | 230 | 0.1149 | sebacic acid | 0.1149 |

### Experiment 2: Effect of Diacid Monomer to Polymerization Temperature and Polymerization Rate

In this experiment, the effect of diacid monomer to the polymerization temperature and the polymerization rate is measured. The polymerization temperature of the unmodified and modified PA11 as well as the measured torque difference between the reaction time at zero and 3 hours were listed in the table 25 below.

Generally speaking, since during the polymerization reaction, the viscosity of the reaction mixture is usually increased as the polymerization degree is increased, the viscosity can be an indicator of the reaction degree of the polymerization. Therefore, a polymerization apparatus connecting to a torque meter was used to indirectly measure the viscosity of the reaction mixture. That is, the measured torque difference can represent the reaction degree of polymerization.

For example, in U.S. Pat. No. 5,994,481, it disclose that in the polymerization apparatus used, the power of a motor is transmitted to a stirrer via oil-lubricated transmission box and speed reduction gear. Therefore, the torque between the motor and the transmission box or the speed reduction gear can be measured with a torque meter. The viscosity of a reaction mixture is then calculated from the measured torque and the number of rotation of the stirrer. U.S. Pat. No. 5,994,481 is entirely incorporated herein by reference.

For example, in this experiment, the rotation speed of the stirrer is 104 rpm. Therefore, the obtained polyamide can be applied in general plastics processing, such as inject molding, when the torque difference is 25 or more. The obtained polyamide can be used in spinning process when the measured torque difference is 30 or more.

TABLE 2
Measured torque value at the time of the beginning and 3 hours

| | Polymerization | Measured torque |
|---|---|---|
| Example | temp. (° C.) | difference* |
| E1 | 230 | 25 |
| E2 | 230 | 32 |
| E3 | 230 | 35 |
| E4 | 230 | 35 |
| C1 | 260 | 8 |
| C2 | 260 | 3 |

*Rotation speed of the stirrer is 104 rpm

From the tables 1 and 2 above, it can be known that, in examples E1, E4. C1, and C2, equal amount of PEO diamine was added, only diacid monomers are different. In example E1, 11-aminoundecanoic acid itself could be polymerized at 230° C. After reacting for 3 hours, the torque difference had reached 25, which means that the polymerization degree of the example El can be processed by general plastics processing.

In examples C1 and C2, PEO diamine and an aliphatic diacid (adipic acid or sebacic acid here) were added. Although the polymerization temperature was increased to 260° C., after reacting for 3 hours, the measured torque difference were all below 10, which means that the main components of the reaction mixture were still monomers and oligomers.

However, in example E4, PEO diamine and an aromatic diacid (terephthalic acid here) were added. The polymerization can be performed at 230° C. again, and the measured torque difference was 35 after polymerization for 3 hours, which means that the polymerization degree of example E4 can be processed by melt spinning.

In examples E2, E3 and E4, various amount of PEO diamine and terephthalic acid were added. It can be seen that only adding a small amount of aromatic diacid couldc maintain the polymerization temperature at 230° C., and the measured torque difference were all above 30 after polymerization for 3 hours, which means that the modified polyamide obtained of examples E2, E3, and E4 can be melt spun.

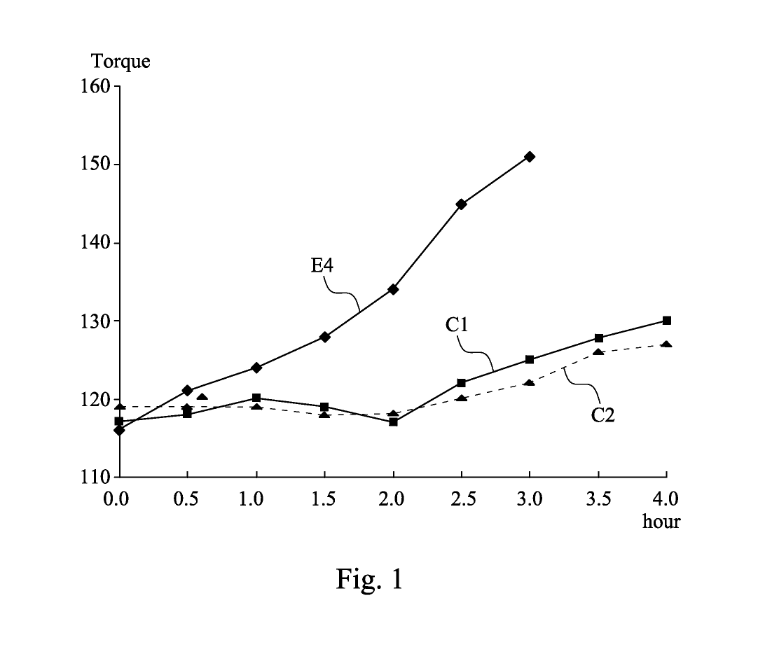

The measured torques during the above polymerization of examples E4, C1, and C2 are also shown in FIG. 1. From the slopes of the torque increasing curves in FIG. 1, it can be known that the reaction rate of the example E4 was much faster than the examples C1 and C2.

### Experiment 3: Physical Properties of the Obtained Polyamide

In this experiment, the melting temperatures and the pyrolysis temperatures of the obtained polyamides, which were polymerized for only 3 hours, were measured for examples E1-E4 and C1-C2. The obtained results are listed in table 3 below. Comparing the melting temperatures and the pyrolysis temperatures of the examples E1 to E4, the melting temperatures and the pyrolysis temperatures both were slightly decreased as the content of the PEO diamine and the terephthalic acid were increased. Since the melting temperature of the modified polyamides of examples E2-E4 were decreased, there is no pyrolysis occurred during the melt spinning process. As for the pyrolysis temperatures of examples E2-E4, since the lowest pyrolysis temperature was 384.5° C., which is still higher than the melt spinning temperature of 260° C., as listed in the table 4 below. Therefore, examples E2-E4 were thermal stable during the melt spinning process.

TABLE 3
Melting temperatures and pyrolysis temperature of polyamide

| | Melting | Pyrolysis |
|---|---|---|
| Example | temp. (° C.) | temp. (° C.) |
| E1 | 190.7 | 411.7 |
| E2 | 187.6 | 401.5 |
| E3 | 180.8 | 391.0 |
| E4 | 181.9 | 384.5 |
| C1* | — | — |
| C2* | — | — |

*Since the polymerization time of examples C1 and C2 were only 3 hours, it can be known that the main components in the reaction mixtures were monomers and oligomers from the torque difference listed in table 2. Hence, the melting temperature and pyrolysis temperature were not measured.

### Experiment 4: Modified Long Chain Polyamide Fibers

In this experiment, the obtained polyamides of examples E1 and E4 were undergone melt spinning. The conditions of the melt spinning for E1 and E4 were the same, except that the melt spinning temperature. The melt spinning temperatures and physical properties of the obtained polyamide fibers are listed in table 4 below.

TABLE 4
Melt spinning temperature and physical
properties of polyamide fibers

| Examples | | E1 | E4 |
|---|---|---|---|
| Fibers | Melt spinning temp (° C.) | 290 | 260 |
| | FDY | 70d/48f | 70d/48f |
| | Strength (gf/d) | 4.60 | 4.12 |
| | Elongation rate (%) | 37.1 | 39.8 |
| Fabrics | Moisture absorption rate (%) | 0.40 | 3.62 |
| | Moisture desorption rate (%) | 0.01 | 1.87 |

In table 4, the method of calculating the moisture absorption and desorption rates is described below. A sample was dried in an oven at 105° C. for 2 hours first to measure the dry weight, W1. Then, the sample was placed in an environment of 20° C. and 65% RH for 24 hours to measure the weight, W2. Next, the sample was placed in an environment of 30° C. and 90% RH for 24 hours to measure the weight, W3. Finally, the sample was placed in an environment of 20° C. and 65% RH for 24 hours to measure the weight, W4.

Accordingly, the moisture absorption and desorption rates were calculated by the formulas (1) and (2) below.

$$\begin{matrix}\begin{matrix}Moisture absorption rate ( \% ) = [ ( W 3 - W 1 ) / W 1 - \\ ( W 2 - W 1 ) / W 1 ] \times 100 \% \\ = ( W 3 - W 2 ) / W 1 \times 100 \%\end{matrix} & ( 1 ) \\ \begin{matrix}Moisture desorption rate ( \% ) = [ ( W 3 - W 1 ) / W 1 - \\ ( W 4 - W 1 ) / W 1 ] \times 100 \% \\ = ( W 3 - W 4 ) / W 1 \times 100 \%\end{matrix} & ( 2 )\end{matrix}$$

The modified PA11 of example E4 was 260° C., and the unmodified PA11 of example E1 was 290° C. Therefore, the melt spinning temperature of the modified PA11 of example E4 was 30° C. lower than the unmodified PA11 of example E1.

Comparing the fiber strength and elongation rate of examples E1 and E4, they are almost the same, which shows that the fibers of example E4 was suitable to be used to be woven to form fabrics.

As for the moisture absorption and desorption rates of the obtained fabrics, example E4 is much better than example E1. Therefore, fabrics made from the fibers of example E4 can provide wearer much comfortable touch feeling. In addition, since the modified PA11 of example E4 had higher moisture absorption and desorption rates, which also means that the modified PA11 of example E4 has higher moisture content. Therefore, the higher moisture content can help to increase the flowability of the melted modified polyamide, and thus decrease the melt spinning temperature.

Accordingly, the embodiments above of this invention can perform copolymerization reaction at a lower temperature with a faster reaction rate, and can be melt spun at the operation temperature of PA6. Therefore, the advantages of the long chain polyamide can be more to play in functional fabrics.

All the features disclosed in this specification (including any accompanying claims, abstract, and drawings) may be replaced by alternative features serving the same, equivalent or similar purpose, unless expressly stated otherwise. Thus, each feature disclosed is one example only of a generic series of equivalent or similar features.

What is claimed is:

1. A modified long chain polyamide polymerized by monomers comprising:
a long-aliphatic-chain monomer with an amine group and a carboxylic group and having 11-18 carbons, wherein the added amount of the long-aliphatic-chain monomer is 100 parts by weight; and
equimolar of an aromatic diacid and polyethyleneoxy diamine, wherein the added amount of the polyethyleneoxy diamine is 1-30 parts by weight.

2. The modified polyamide of claim 1, wherein the long-aliphatic-chain monomer is 11-aminoundecanoic acid or 12-aminododecanoic acid.

3. The modified polyamide of claim 2, wherein the aromatic diacid is terephthalic acid.

4. The modified polyamide of claim 1, wherein the aromatic diacid is terephthalic acid, isophthalic acid, bibenzoic acid, naphthalene dicarboxylic acid, 4,4′-biphenyl dicarboxylic acid, bis(p-carboxyphenyl) methane, ethylene bis(p-benzoic acid), 1,4-tetramethylene bis(p-oxybenzoic acid), ethylene bis(p-oxybenzoic acid), or 1,3-trimethylene bis(p-oxybenzoic acid).

5. A fiber made from the modified polyamide of claim 1.

6. The fiber of claim 5, wherein the long-aliphatic-chain monomer is 11-aminoundecanoic acid or 12-aminododecanoic acid.

7. The fiber of claim 6, wherein the aromatic diacid is terephthalic acid.

8. The fiber of claim 5, wherein the aromatic diacid is terephthalic acid, isophthalic acid, bibenzoic acid, naphthalene dicarboxylic acid, 4,4′-biphenyl dicarboxylic acid, bis(p-carboxyphenyl) methane, ethylene bis(p-benzoic acid), 1,4-tetramethylene bis(p-oxybenzoic acid), ethylene bis(p-oxybenzoic acid), or 1,3-trimethylene bis(p-oxybenzoic acid).

9. A method of spinning a fiber, the method comprising:
preparing a modified long chain polyamide by copolymerizing monomers comprising:
a long-aliphatic-chain monomer with an amine group and a carboxylic group and having 11-18 carbons, wherein the added amount of the long-aliphatic-chain monomer is 100 parts by weight; and
equimolar of an aromatic diacid and polyethyleneoxy diamine, wherein the added amount of the polyethyleneoxy diamine is 1-30 parts by weight; and
melt spinning the modified long chain polyamide.

10. The method of clam 9, wherein the long-aliphatic-chain monomer is 11-aminoundecanoic acid or 12-aminododecanoic acid.

11. The method of clam 10, wherein the aromatic diacid is terephthalic acid.

12. The method of clam 6, wherein the aromatic diacid is terephthalic acid, isophthalic acid, bibenzoic acid, naphthalene dicarboxylic acid, 4,4′-biphenyl dicarboxylic acid, bis(p-carboxyphenyl) methane, ethylene bis(p-benzoic acid), 1,4-tetramethylene bis(p-oxybenzoic acid), ethylene bis(p-oxybenzoic acid), or 1,3-trimethylene bis(p-oxybenzoic acid).
